(19) United States
(12) Patent Application Publication
(10) Pub. No.: US 2025/0115508 A1
(43) Pub. Date: Apr. 10, 2025

(54) GLASS MELTING FURNACES AND VESSELS WITH IMPROVED ELECTRICAL RESISTIVITY

(71) Applicant: CORNING INCORPORATED, CORNING, NY (US)

(72) Inventors: Benjamin Zain Hanson, Big Flats, NY (US); Jason Arthur Howles, Corning, NY (US); Edward Lee Kimble, III, Painted Post, NY (US)

(21) Appl. No.: 18/836,574

(22) PCT Filed: Feb. 17, 2023
(86) PCT No.: PCT/US2023/013265

§ 371 Date: Aug. 7, 2024

Related U.S. Application Data
(60) Provisional application No. 63/313,883, filed on Feb. 25, 2022.

(51) Int. Cl. C03B 5/43; C03B 5/02

(52) U.S. Cl. CPC C03B 5/43; C03B 5/02

(57) ABSTRACT

Glass melting furnaces include a melting vessel that includes a floor, a feeding mechanism configured to feed raw materials into the melting vessel, a heating mechanism configured to convert raw materials fed into the melting vessel into molten glass, and a layer comprising an electrical resistivity enhancing material that is configured to diffuse into at least one layer of the floor that comprises a refractory ceramic material.

### CROSS REFERENCE TO RELATED APPLICATION

This application claims the benefit of priority under 35 U.S.C. § 119 of U.S. Provisional Application Ser. No.: 63/313,883 filed on Feb. 25, 2022, the content of which is relied upon and incorporated herein by reference in its entirety.

### FIELD

The present disclosure relates generally to glass melting furnaces and vessels and more particularly to glass melting furnaces and vessels with improved electrical resistivity.

### BACKGROUND

In the production of glass articles, such as glass sheets for display applications, including televisions and hand-held devices, such as telephones and tablets, a glass composition is typically melted in a melting vessel. During operation of the melting vessel over the course of a production campaign, hot spots can develop in certain areas of the melting vessel, which, over time, may result in degradation of melting vessel materials, eventually causing a phenomenon known as “fire through” wherein mechanical failure of melting vessel material ultimately occurs. Such occurrence can cause significant disruption to a production campaign as well as substantial repair costs. Accordingly, it would be desirable to minimize such occurrence.

### SUMMARY

Embodiments disclosed herein include a glass melting vessel. The glass melting vessel includes a heating mechanism and a floor. The floor includes at least one layer that includes a refractory ceramic material. The floor also includes a layer that includes an electrical resistivity enhancing material. The electrical resistivity enhancing material is configured to diffuse into the at least one layer that includes the refractory ceramic material during operation of the glass melting vessel.

Embodiments disclosed herein also include a method of operating a glass melting vessel. The glass melting vessel includes a floor that includes at least one layer that includes a refractory ceramic material. The floor also includes a layer that includes an electrical resistivity enhancing material. The method includes feeding raw materials into the melting vessel. The method also includes converting the raw materials fed into the melting vessel into molten glass. In addition, the method includes diffusing the electrical resistivity enhancing material into the at least one layer that includes the refractory ceramic material during operation of the glass melting vessel.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a schematic view of an example fusion down draw glass-making apparatus and process;

FIG. 2 is a schematic side cutaway view of an example glass melting vessel in accordance with embodiments disclosed herein;

FIG. 3 is schematic top cutaway view of the example glass melting vessel of FIG. 2;

FIG. 4 is schematic end cutaway view of the example glass melting vessel of FIGS. 2-3;

FIG. 5 is a schematic bottom cutaway view of the example glass melting vessel of FIGS. 2-4;

FIG. 6 is a schematic side cutaway view of a floor of an example glass melting vessel in accordance with embodiments disclosed herein;

FIG. 7 is a schematic side cutaway view of a floor of an example glass melting vessel in accordance with embodiments disclosed herein;

FIG. 8 is a schematic top cutaway view of a portion of the floor of FIG. 7;

FIG. 9 is a schematic side cutaway view of a floor of an example glass melting vessel in accordance with embodiments disclosed herein;

FIG. 10 is a schematic side cutaway view of a floor of an example glass melting vessel in accordance with embodiments disclosed herein;

FIG. 11 is a schematic end cutaway view of a floor region of an example glass melting vessel in accordance with embodiments disclosed herein;

FIG. 12 is a schematic top cutaway view of a portion of the floor of FIG. 11;

FIG. 13 is a schematic end cutaway view of a floor of an example glass melting vessel in accordance with embodiments disclosed herein; and

FIG. 14 is a schematic top cutaway view of a portion of the floor of FIG. 13.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “heating mechanism” refers to a mechanism that provides heat to a glass melting furnace and/or melting vessel, such as through the operation of electrodes, combustion burners, or both.

As used herein, the term “electrical resistivity enhancing material” refers to a material that increases the electrical resistivity of a material or layer of material into which it is incorporated, such as increased electrical resistivity of the material or layer of material during operating conditions of a glass melting furnace and/or melting vessel.

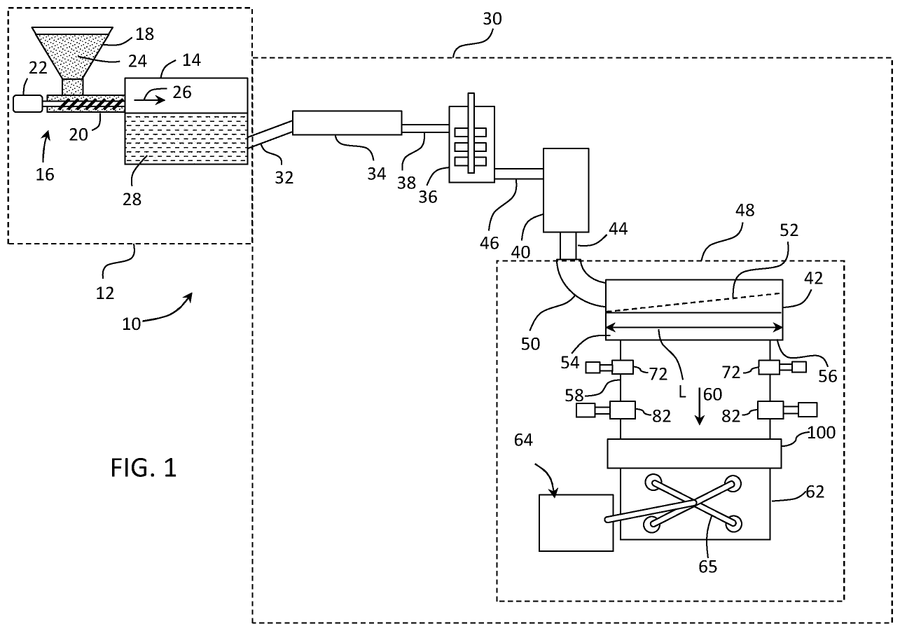

Shown in FIG. 1 is an exemplary glass manufacturing apparatus 10. In some examples, the glass manufacturing apparatus 10 can comprise a glass melting furnace 12 that can include a melting vessel 14. Glass melting furnace 12 including melting vessel 14 can include one or more additional components such as heating elements or mechanisms (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. However, other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen produced by the temperature-induced chemical reduction of the fining agent(s) can diffuse or coalesce into bubbles produced in the molten glass during the melting process. The enlarged gas bubbles can then rise to a free surface of the molten glass in the fining vessel and thereafter be vented out of the fining vessel. The bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. While mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass-making apparatus can comprise a trough 52 positioned in an upper surface of the forming body 42 and converging forming surfaces 54 that converge in a draw direction along a bottom edge 56 of the forming body 42. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

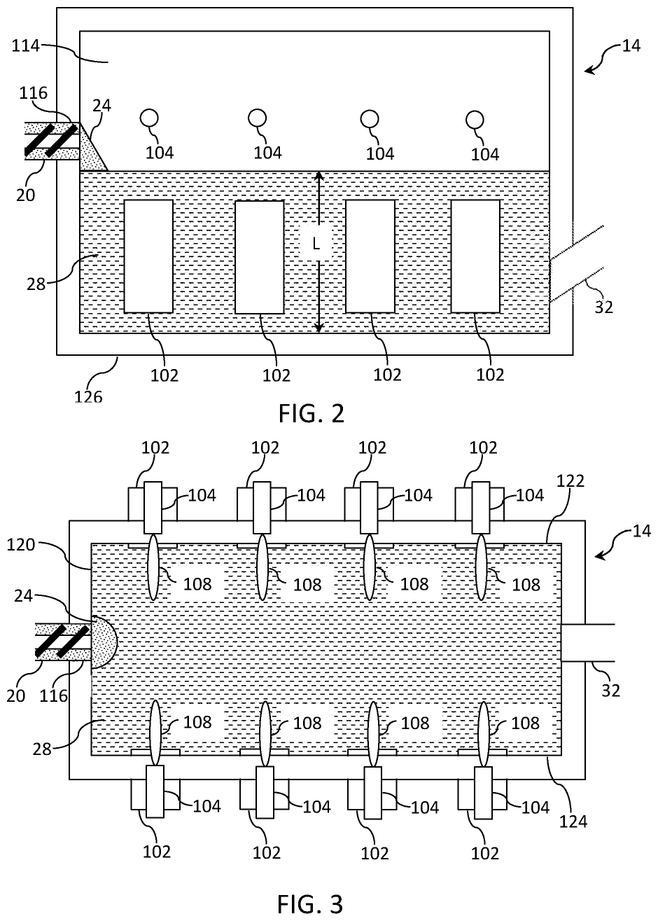

FIG. 2 shows a schematic side cutaway view of an example glass melting vessel 14 in accordance with embodiments disclosed herein. Glass melting vessel 14 includes a chamber 114 positioned above a floor 126, wherein raw material delivery device 20 delivers a predetermined amount of raw batch materials 24 into the chamber 114 through feed port 116, wherein combination of raw material delivery device 20 and feed port 116 comprises a feeding mechanism. Glass melting vessel 14 also includes a plurality of electrodes 102 and a plurality of combustion burners 104.

In operation, plurality of electrodes 102 and plurality of combustion burners 104 heat chamber 114 such that raw batch materials 24 are melted into molten glass 28 up to a predetermined level (L) within chamber 114. As can be seen in FIG. 2, plurality of combustion burners 104 are positioned above the predetermined level (L) and plurality of electrodes 102 are positioned below the predetermined level (L).

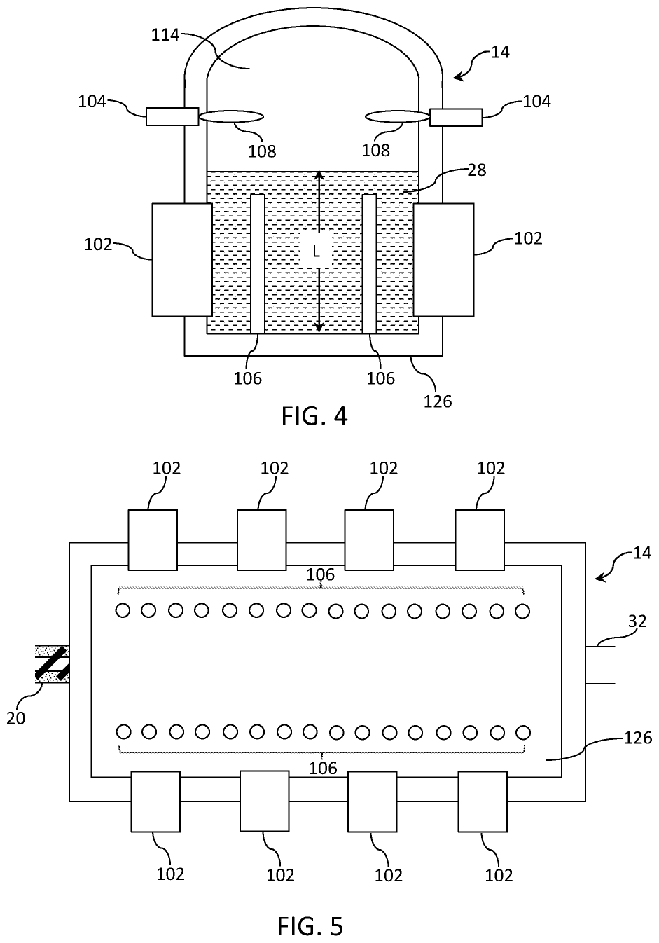

FIGS. 3 and 4, show, respectively, schematic top and end cutaway views of the example glass melting vessel 14 of FIG. 2. As can be seen in FIGS. 3 and 4, each combustion burner 104 emits a flame 108 into the chamber 114. In addition, as shown in FIG. 3, feed port 116 is positioned on a first wall 120 of the chamber 114 and the plurality of combustion burners 104 are positioned on second and third walls 122, 124 of the chamber 114, the second and third walls 122, 124 each extending in directions that are generally parallel to each other and generally perpendicular to the first wall 120. First, second, and third walls, 120, 122, and 124 are also generally perpendicular to floor 126.

As shown in FIG. 4, glass melting vessel 14 includes electrodes 106 extending from floor 126, wherein electrodes 106 are positioned below the predetermined level (L). As further shown in FIG. 4, combustion burners 104 emit flames 108 in a direction that is generally parallel to predetermined level (L).

While FIGS. 2-4, show a glass melting vessel 14 that includes electrodes 102 extending from walls of chamber 114, electrodes 106 extending from floor 126, and combustion burners 104, embodiments disclosed herein can include those in which glass melting vessel 14 does not include one or more of these components. Collectively, one or more of these components comprise a heating mechanism.

In certain exemplary embodiments, electrodes 102 and/or electrodes 106 comprise at least one of tin oxide or molybdenum. In certain exemplary embodiments, electrodes 102 comprise tin oxide and electrodes 106 comprise molybdenum.

FIG. 5 shows a schematic bottom cutaway view of the example glass melting vessel 14 of FIGS. 2-4. As shown in FIG. 5, electrodes 106 extending from floor 126 comprise a plurality of electrodes 106 extending along linear and generally parallel lengths of glass melting vessel 14.

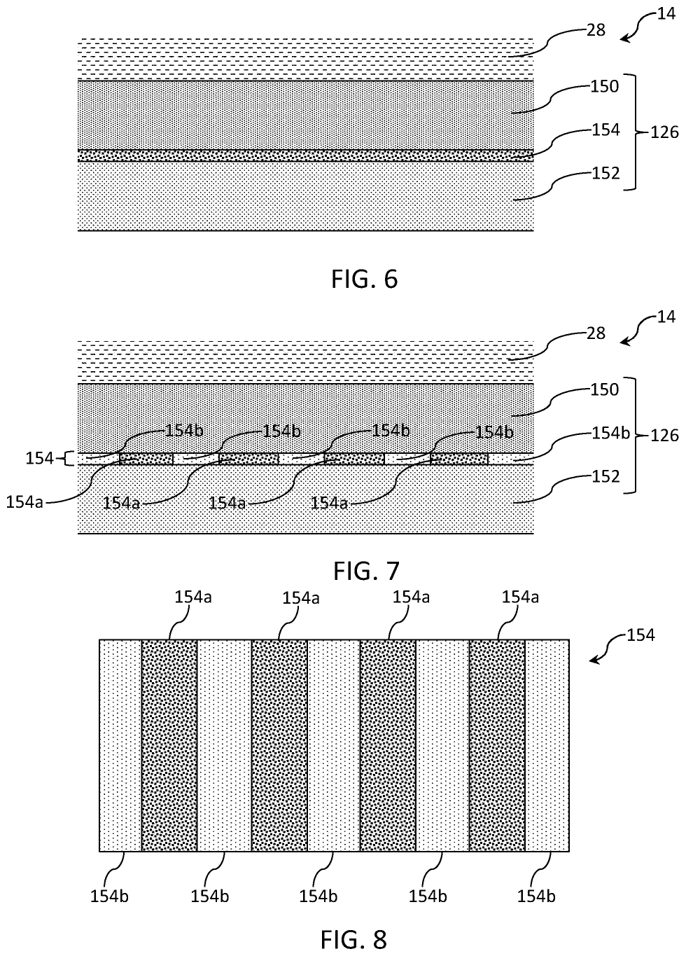

FIG. 6 shows a schematic side cutaway view of a floor 126 of an example glass melting vessel 14 in accordance with embodiments disclosed herein. As shown in FIG. 6, floor 126 includes a plurality of layers. Specifically, floor 126 comprises a first layer 150 comprising a first refractory ceramic material and a second layer 152 comprising a second refractory ceramic material. Floor 126 also comprises a layer 154 comprising an electrical resistivity enhancing material that is positioned between the first layer 150 and the second layer 152.

In certain exemplary embodiments, first refractory ceramic material comprises zirconia, such as fused zirconia, including CZ-type fused zirconia, such as Scimos CZ Scimos Z, Xilec 9, Xilec 5, or ER1195 available from St. Gobain, Monofrax ZHR or Mono Z available from Monofrax LLC, or ZBX9510 or ZBX9540 available from Asahi Ceramics.

In certain exemplary embodiments, second refractory ceramic material comprises alumina, zircon, or alumina zirconia silica (AZS), such as A1148 (alumina) and ZS1300 (zircon) available from St. Gobain, Mono CS-3 or Mono CS-5 available from Monofrax LLC, or Supral S70, Supral AZ 50, or Supral AZ 70 available from RHI Magnesita.

In certain exemplary embodiments, electrical resistivity enhancing material comprises at least one material selected from Ta, Nb, Mo, W, V, or Cr, and/or oxides of the same, including Ta₂O₅, Nb₂O₅, MoO₃, WO₃, V₂O₅, or CrO₃. In certain exemplary embodiments, electrical resistivity enhancing material comprises Ta₂O₅.

In certain exemplary embodiments, layer 154 comprising electrical resistivity enhancing material comprises at least one of alumina, silica, or glass, such as alumina silicate glass, including boron containing alumina silicate glass.

In certain exemplary embodiments, layer 154 comprising electrical resistivity enhancing material has a thickness ranging from about 0.03 inches to about 6 inches, such as from about 0.1 inches to about 3 inches, and further such as from about 0.5 inches to about 1 inch.

In certain exemplary embodiments, electrical resistivity enhancing material comprises from about 0.1 to about 100, such as from about 1 to about 80, and further such as from about 5 to about 50 weight percent of layer 154 comprising the electrical resistivity enhancing material.

FIG. 7 shows a schematic side cutaway view of a floor 126 of an example glass melting vessel 14 in accordance with embodiments disclosed herein and FIG. 8 shows a schematic top cutaway view of a portion of the floor 126 of FIG. 7. As shown in FIGS. 7 and 8, layer 154 comprising electrical resistivity enhancing material comprises first regions 154a and second regions 154b. First regions 154a comprise higher concentrations of electrical resistivity enhancing material than the second regions 154b. For example, prior to or during diffusion of electrical resistivity enhancing material, first regions 154a may comprise at least about 1.1 times, such as at least about 1.5 times, and further such as at least about 2 times, and yet further such as at least about 10 times higher concentration of electrical resistivity enhancing material than second regions, including from about 1.1 times to about 1000 times, and further including from about 1.5 times to about 500 times, and yet further including from about 2 times to about 200 times, and still yet further from about 5 times to about 100 times higher concentration of electrical resistivity enhancing material than second regions.

And while FIGS. 7 and 8 show alternating rectangular cross-sectional areas of first regions 154a and second regions 154b, embodiments disclosed herein may include other configurations of first regions 154a and second regions 154b such as other polynomial cross-sections and/or shapes of first regions 154a and/or second regions 154b and/or shapes with circular or elliptical cross-sections, such as spherical or cylindrical shapes of first regions 154a and/or second regions 154b, and/or configurations wherein at least one of first regions 154a surround at least one of second regions 154b and/or wherein at least one of second regions 154b surround at least one of first regions 154a.

For example, first regions 154a may comprise a higher concentration of at least one of Ta, Nb, Mo, W, V, or Cr and/or Ta₂O₅, Nb₂O₅, MoO₃, WO₃, V₂O₅, or CrO₃than second regions 154b. Meanwhile, second regions 154b may comprise a higher concentration of at least one of alumina, silica, or glass than first regions 154a.

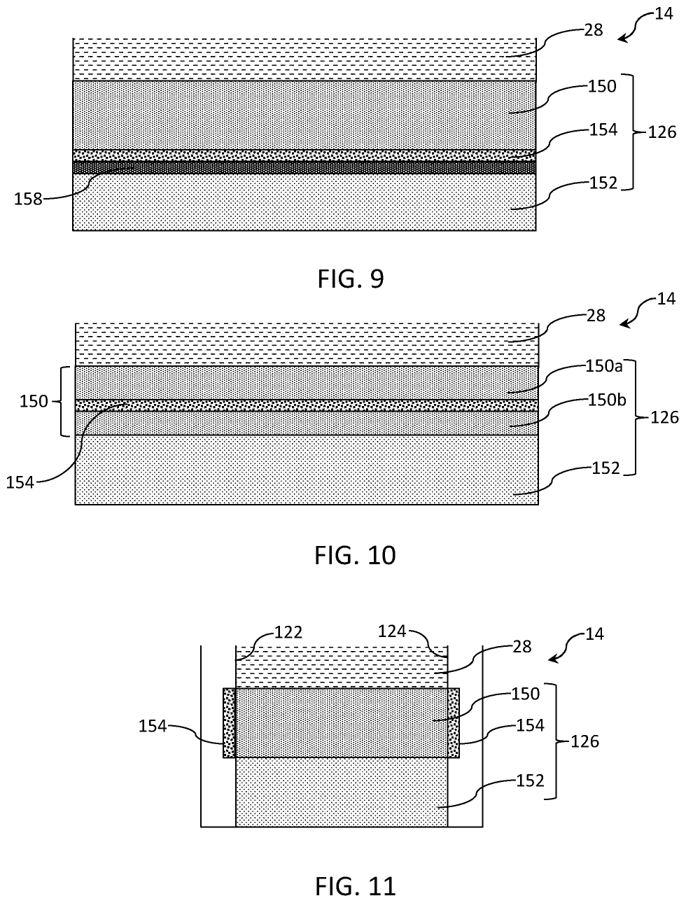

FIG. 9 shows a schematic side cutaway view of a floor 126 of an example glass melting vessel 14 in accordance with embodiments disclosed herein. The example glass melting vessel 14 of FIG. 9 is similar to that of FIG. 6 except that a shielding layer 158 is positioned between the layer 154 comprising the electrical resistivity enhancing material and the second layer 152. Shielding layer 158 can mitigate or prevent diffusion of electrical resistivity enhancing material into second layer 152 and/or facilitate increased diffusion of electrical resistivity enhancing material into first layer 150.

In certain exemplary embodiments, shielding layer 158 comprises a high crystalline (at least 95 wt % crystalline phase), high porosity (at least 10% porosity by volume) material which can, for example, comprise one or more solid paver, brick, or monolithic powder layers. For example, shielding layer 158 may comprise rebonded fused mullites, alumina, or andalusite, such as Supral E 75, Supral K 99, Supral S 70, or Supral S 60 available from RHI Magnesita. In certain exemplary embodiments, shielding layer 158 has a thickness ranging from about 0.5 inches to about 3 inches, such as from about 1 inch to about 2 inches.

FIG. 10 shows a schematic side cutaway view of a floor 126 of an example glass melting vessel 14 in accordance with embodiments disclosed herein. The example glass melting vessel 14 of FIG. 10 is similar to that of FIG. 6 except layer 154 comprising the electrical resistivity enhancing material is positioned within first layer 150 such that a first portion 150a of first layer 150 is positioned above layer 154 comprising the electrical resistivity enhancing material and a second portion 150b of first layer 150 is positioned below layer 154 comprising the electrical resistivity enhancing material.

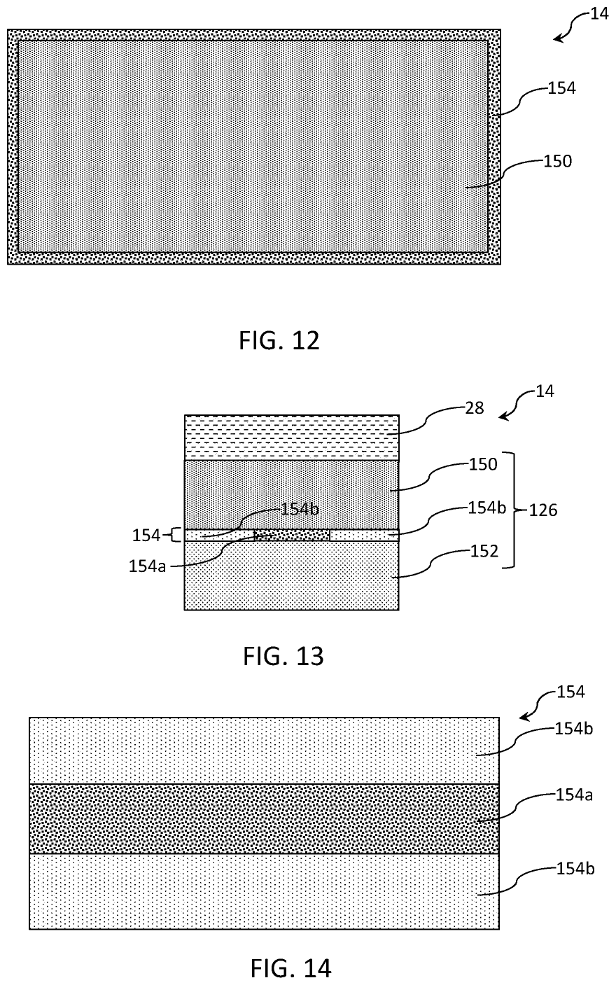

FIG. 11 shows a schematic end cutaway view of a floor region of an example glass melting vessel 14 in accordance with embodiments disclosed herein and FIG. 12 shows a schematic top cutaway view of a portion of the floor 126 of FIG. 11. As shown in FIGS. 11 and 12, layer 154 comprising the electrical resistivity enhancing material surrounds the first layer 150. As further shown in FIG. 11, layer 154 comprising the electrical resistivity enhancing material is embedded in walls (e.g., second and third walls 122, 124) of glass melting vessel 14.

FIG. 13 shows a schematic end cutaway view of a floor 126 of an example glass melting vessel 14 in accordance with embodiments disclosed herein and FIG. 14 shows a schematic top cutaway view of a portion of the floor 126 of FIG. 13. As shown in FIGS. 13 and 14, layer 154 comprising electrical resistivity enhancing material comprises first region 154a and second regions 154b, wherein first region 154a extends along a central length of floor 126 and second regions 154b extend along opposing lengths of floor 126 relative to first region 154a. As with the floor 126 shown and described with respect to FIGS. 7 and 8, first region 154a comprises a higher concentration of electrical resistivity enhancing material than the second regions 154b.

In operation, a heating mechanism comprising, for example, at least one of electrodes 102 or 106 or combustion burners 104, converts raw materials 24 fed into glass melting vessel 14 into molten glass 28. Such heating mechanism not only serves to heat the raw materials 24 but also heats components of glass melting vessel 14, including floor 126. As floor 126 is heated, the diffusivity of the electrical resistivity enhancing material of layer 154 is increased such that, during operation of the glass melting vessel 14, the electrical resistivity enhancing material is gradually diffused into at least one layer comprising refractory ceramic material (e.g., first layer 150). This, in turn, increases the electrical resistivity of the at least one layer comprising refractory ceramic material (e.g., first layer 150).

For example, during steady state operation of glass melting vessel 14, a temperature of layer 154 comprising electrical resistivity enhancing material may range from about 1300° C. to about 1500° C., such as from about 1350° C. to about 1450° C. Such temperature range can enable increased diffusivity of the electrical resistivity enhancing material while still maintaining the mechanical integrity of layer 154 as well as that of first layer 150 and second layer 152.

Embodiments disclosed herein can, for example, enable at least about 5%, such as at least about 10%, such as from about 5% to about 25% greater electrical resistivity of floor 126 (or portion of floor 126 such as first layer 150) at a given temperature and production campaign duration as compared to a melting vessel 14 that does not comprise layer 154 comprising an electrical resistivity enhancing material that is configured to diffuse into the at least one layer comprising refractory ceramic material (e.g., first layer 150) during operation of the glass melting vessel 14.

Such increased electrical resistivity can, in turn, enable glass melting furnaces 12 and/or glass melting vessels 14 wherein the occurrence of fire through is mitigated or delayed (thereby extending the service life of the melting furnaces 12 and/or melting vessels 14), such as delayed by a period of at least about a year during a production campaign, as compared to a melting vessel 14 that does not comprise layer 154 comprising an electrical resistivity enhancing material that is configured to diffuse into the at least one layer comprising refractory ceramic material (e.g., first layer 150) during operation of the glass melting vessel 14.

In addition, given that fire through often occurs near or below areas of highest electrical current density, embodiments disclosed herein include those in which layer 154 comprising an electrical resistivity enhancing material comprises one or more first regions 154a comprising higher concentrations of electrical resistivity enhancing material than one or more second regions 154b (such as that shown in FIGS. 7 and 8) wherein the regions 154a comprising higher concentrations of electrical resistivity enhancing material are positioned near or below areas of highest electrical current density, such near or below areas where electrodes 102 and/or 106 face each other across opposing sides of glass melting vessel 14.

In certain exemplary embodiments, electrical resistivity enhancing material, such as that present in layer 154, may be encapsuled or encased in a material that can dissolve or disintegrate over time to further control a rate of diffusion, such as a rate of diffusion within a predetermined range.

In certain exemplary embodiments, one or more layers comprising refractory ceramic material (e.g., first layer 150) may be pre-doped with an electrical resistivity enhancing material prior to in situ diffusion of electrical resistivity enhancing material during operation of glass melting vessel 14 (e.g., from layer 154 to first layer 150). For example, one or more layers comprising refractory ceramic material (e.g., first layer 150) may be pre-doped with at least one material selected from Ta₂O₅, Nb₂O₅, MoO₃, WO₃, V₂O₅, or CrO₃.

While the above embodiments have been described with reference to fusion down draw processes, it is to be understood that such embodiments are also applicable to other glass forming processes, such as slot draw processes, float processes, up-draw processes, and press-rolling processes.

Such processes can be used to make glass articles, which can be used, for example, in electronic devices as well as for other applications.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. A glass melting vessel comprising:
a heating mechanism;
a floor comprising at least one layer comprising a refractory ceramic material; and a layer comprising an electrical resistivity enhancing material, the electrical resistivity enhancing material configured to diffuse into the at least one layer comprising the refractory ceramic material during operation of the glass melting vessel.

2. The glass melting vessel of claim 1, wherein the at least one layer comprises a first layer comprising a first refractory ceramic material and a second layer comprising a second refractory ceramic material; and the layer comprising the electrical resistivity enhancing material is positioned between the first layer and the second layer.

3. The glass melting vessel of claim 2, wherein a shielding layer is positioned between the layer comprising the electrical resistivity enhancing material and the second layer.

4. The glass melting vessel of claim 2, wherein the first refractory ceramic material comprises zirconia and the second refractory ceramic material comprises alumina.

5. The glass melting vessel of claim 1, wherein the layer comprising the electrical resistivity enhancing material comprises first regions and second regions, wherein the first regions comprise higher concentrations of electrical resistivity enhancing material than the second regions.

6. The glass melting vessel of claim 1, wherein the layer comprising the electrical resistivity enhancing material surrounds the at least one layer comprising a refractory ceramic material.

7. The glass melting vessel of claim 1, wherein the electrical resistivity enhancing material comprises from about 0.1 to about 100 weight percent of the layer comprising the electrical resistivity enhancing material.

8. The glass melting vessel of claim 1, wherein the electrical resistivity enhancing material comprises at least one material selected from Ta, Nb, Mo, W, V, Cr, Ta₂O₅, Nb₂O₅, MoO₃, WO₃, V₂O₅, or CrO₃.

9. The glass melting vessel of claim 8, wherein the electrical resistivity enhancing material comprises Ta₂O₅.

10. The glass melting vessel of claim 1, wherein the layer comprising the electrical resistivity enhancing material comprises at least one of alumina, silica, or glass.

11. A method of operating a glass melting vessel, the glass melting vessel comprising:
a floor comprising at least one layer comprising a refractory ceramic material; and
a layer comprising an electrical resistivity enhancing material;
the method comprising:
feeding raw materials into the melting vessel;
converting the raw materials fed into the melting vessel into molten glass; and
diffusing the electrical resistivity enhancing material into the at least one layer comprising the refractory ceramic material during operation of the glass melting vessel.

12. The method of claim 11, wherein the at least one layer comprises a first layer comprising a first refractory ceramic material and a second layer comprising a second refractory ceramic material; and the layer comprising the electrical resistivity enhancing material is positioned between the first layer and the second layer.

13. The method of claim 12, wherein a shielding layer is positioned between the layer comprising the electrical resistivity enhancing material and the second layer.

14. The method of claim 12, wherein the first refractory ceramic material comprises zirconia and the second refractory ceramic material comprises alumina.

15. The method of claim 11, wherein the layer comprising the electrical resistivity enhancing material comprises first regions and second regions, wherein the first regions comprise higher concentrations of electrical resistivity enhancing material than the second regions.

16. The method of claim 11, wherein the layer comprising the electrical resistivity enhancing material surrounds the at least one layer comprising a refractory ceramic material.

17. The method of claim 11, wherein the electrical resistivity enhancing material comprises from about 0.1 to about 100 weight percent of the layer comprising the electrical resistivity enhancing material.

18. The method of claim 11, wherein the electrical resistivity enhancing material comprises at least one material selected from Ta, Nb, Mo, W, V, Cr, Ta₂O₅, Nb₂O₅, MoO₃, WO₃, V₂O₅, or CrO₃.

19. The method of claim 18, wherein the electrical resistivity enhancing material comprises Ta₂O₅.

20. The method of claim 11, wherein the layer comprising the electrical resistivity enhancing material comprises at least one of alumina, silica, or glass.
